(19) United States
(12) Patent Application Publication
(10) Pub. No.: US 2026/0061500 A1
(43) Pub. Date: Mar. 5, 2026

(54) Tool Holder For A Computer Numerical Control Machine

(71) Applicant: Global CNC Industries, LTD., Plymouth, MI (US)

(72) Inventors: Lambros STASSINOS, Northville, MI (US); Olgert Kristi Papa-Naum, West Bloomfield, MI (US); Jishnu Amrit Patil, Dearborn, MI (US)

(21) Appl. No.: 18/821,541

(22) Filed: Aug. 30, 2024

(51) Int. Cl. B23B 31/12; B23B 31/107; B23Q 11/12

(52) U.S. Cl. CPC B23B 31/1238; B23B 31/1071; B23Q 11/127; B23B 2231/04

(57) ABSTRACT

A tool holder includes a body comprising a base and a spindle housing. A spindle assembly is rotatably coupled to the base. The spindle assembly has an adapter and a spindle. An adapter nut couples the adapter to the spindle. A first movable element is coupled to the spindle housing selectively engaging the spindle. The first movable element comprises a locked and an unlocked position.

### FIELD

The present disclosure relates to a computer numerical control (CNC) machine and, more particularly, to a tool holder for a CNC machine.

### BACKGROUND

This section provides background information related to the present disclosure which is not necessarily prior art.

Tool holders are used in computer numerical control (CNC) machines to hold a tool that is being rotated to shape a workpiece into a desired shape. Tool holders are often bulky and are cumbersome to remove from the CNC machine. Further, to attach or detach a tool within a tool holder, two wrenches are required. One tool is used for holding the spindle and a second tool is used to tighten or loosen an adapter nut. The adapter nut secures the tool to the spindle. Because of the position of the tool holder within the machine, providing a more convenient way to attach/detach the tool to the CNC machine is desirable.

A typical tool holder includes one coolant outlet port. Typically, the position of the coolant outlet port is in an awkward position that does not allow desirable positioning to cool the work. Providing sufficient cooling directed at the workpiece is desirable.

The tool holder is cumbersome to remove from the CNC machine. Typically, seals are used to prevent leakage between the tool holder and the coolant port of the CNC machine. A significant amount of force is required to overcome the resistance provided by the turret tool holder pocket and seals. Because of the extra force required, it is easier to drop the tool holder. If the tool holder is dropped or put into contact with other components, the tool holder may be damaged. Providing a convenient way to remove the tool holder from the CNC machine is therefore desirable.

### SUMMARY

This section provides a general summary of the disclosure, and is not a comprehensive disclosure of its full scope or all of its features.

The tool holder of the present disclosure provides several features that may be used alone or in combination to provide an improved tool holder. For example, the present disclosure provides a tool holder that allows the tool to be removed with one tool or wrench. Further, the present disclosure provides a plurality of coolant outlet ports that allow coolant to be more easily directed at the work surface. The present disclosure also provides a recessed grip to allow the machine tool to be removed from the machine safely and easily.

In one aspect of the disclosure, a tool holder includes a body comprising a base and a spindle housing. A spindle assembly is rotatably coupled to the base. The spindle assembly has an adapter and a spindle. An adapter nut couples the adapter to the spindle. A first movable element is coupled to the spindle housing selectively engaging the spindle. The first movable element comprises a locked and an unlocked position.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a perspective view of a machine tool for accommodating a tool holder according to the present disclosure.

FIG. 2A is a perspective view of a first example of a tool holder according to the present disclosure.

FIG. 2B is a perspective view of the tool holder of FIG. 2A having one movable element in a locked position and one movable element in an unlocked position.

FIG. 2C is a top view of the tool holder of FIG. 2A.

FIG. 2D is a cross-sectional view of the tool holder of FIG. 2A.

FIG. 2E is a second cross-sectional view illustrating the movable element relative to a movable element retainer.

FIG. 2F is a cross-sectional view of the body of the tool holder of FIG. 2A.

FIG. 2G is a cross-sectional view of the base of the body and the coolant passages therethrough.

FIG. 3 is an alternative of a movable element.

FIGS. 4A and 4B illustrate a locked and unlocked position for another alternative of a movable element 130.

FIG. 5 is a perspective view of an axial tool holder according to the present disclosure.

Corresponding reference numerals indicate corresponding parts throughout the several views of the drawings.

### DETAILED DESCRIPTION

Example embodiments will now be described in detail with reference to the accompanying drawings.

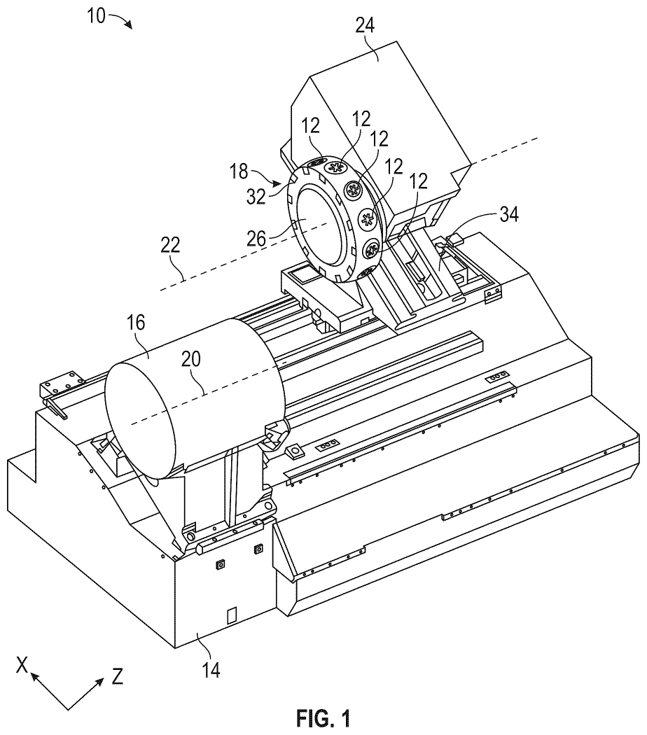

Referring to FIG. 1, a machine tool 10 is used for processing materials into various shapes and contours using a tool (not shown) that is held by a tool holder 12. In FIG. 1, an internal structure of the machine tool is shown by seeing through a cover body that forms an external appearance of the machine tool.

The machine tool 10 in this example is a lathe that performs workpiece processing by bringing the tool into contact with a workpiece that is being rotated. Machine tool 10 has a milling function of performing workpiece processing by bringing a tool that is being rotated into contact with a workpiece that is unmoved. Machine tool 10 performs several types of operations for workpiece processing that are automated through a computer. Machine tool 10 is a CNC (Computer Numerical Control) machine tool that performs several types of operations for workpiece processing automated through numerical control by a computer.

The machine tool 10 has a bed 14, a headstock 16 and a cutting tool rest 18. The bed 14 supports headstock 16 and the tool rest 18, and is installed on a floor surface of a factory or the like. Bed 14 is composed of a metal such as cast iron.

Headstock 16 has a spindle (not shown). The spindle is driven to rotate with respect to a center axis 20 parallel to a Z axis extending in a horizontal direction. The spindle has a tip provided with a chuck mechanism that can detachably hold a workpiece. The workpiece held by the chuck mechanism is rotated with respect to center axis 20 as the spindle is driven to rotate.

The cutting tool rest 18 is provided in a processing area defined and formed by the cover body (not shown). Cutting tool rest 18 is a turret type cutting tool rest and is pivotable with respect to a pivoting center axis 22 (first axis) parallel to the Z axis.

Cutting tool rest 18 has a cutting tool rest base 24, a turret 26 (base), and a plurality of tool holder 12. A motor or the like for driving to pivot cutting tool rest 18 is attached to cutting tool rest base 24. Cutting tool rest base 24 is attached to a cross slide described later.

Turret 26 is provided to protrude from cutting tool rest base 24 in a direction toward headstock 16 in a Z axis direction. Turret 26 has a disk shape having a thickness direction corresponding to an axis direction of pivoting center axis 22. Turret 26 is pivotable with respect to pivoting center axis 22.

The plurality of tool holder 12 are provided at turret 26. The plurality of tool holder 12 are provided on an outer peripheral surface of turret 26. The plurality of tool holders 12 are provided side by side in a peripheral direction of pivoting center axis 22. Each tool holder 12 is configured to hold a tool.

The cutting tool rest 18 is attached to bed 14 via a saddle 34 and the cross slide (not shown). Saddle 34 is movable in the Z axis direction by several types of feed mechanisms, guide mechanisms, servo motors, and the like. The cross slide is movable by the various types of feed mechanisms, guide mechanisms, servo motors, and the like in an X axis direction that is orthogonal to the Z axis and that is inclined with respect to a vertical direction. By respectively moving saddle 34 and the cross slide in the Z axis direction and the X axis direction, a position for processing the workpiece by a tool held by a tool holder 12 can be moved in a Z-X axes plane.

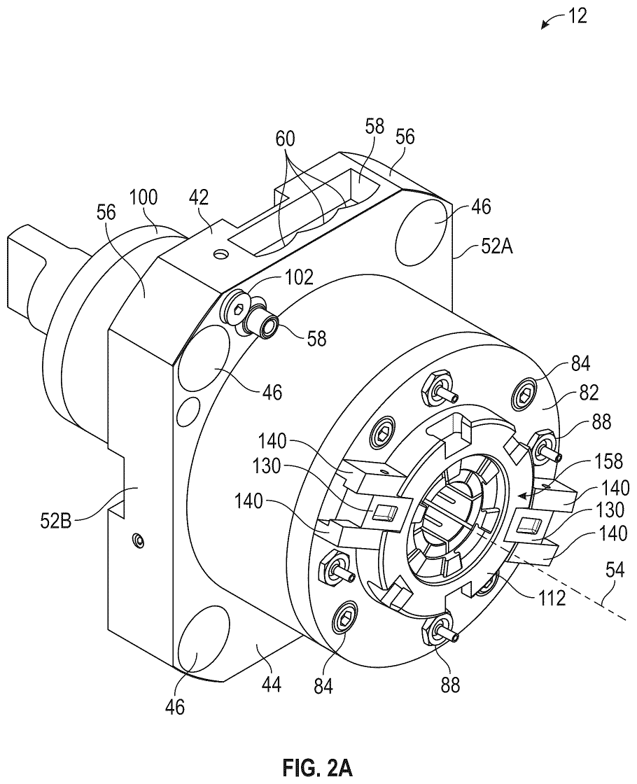

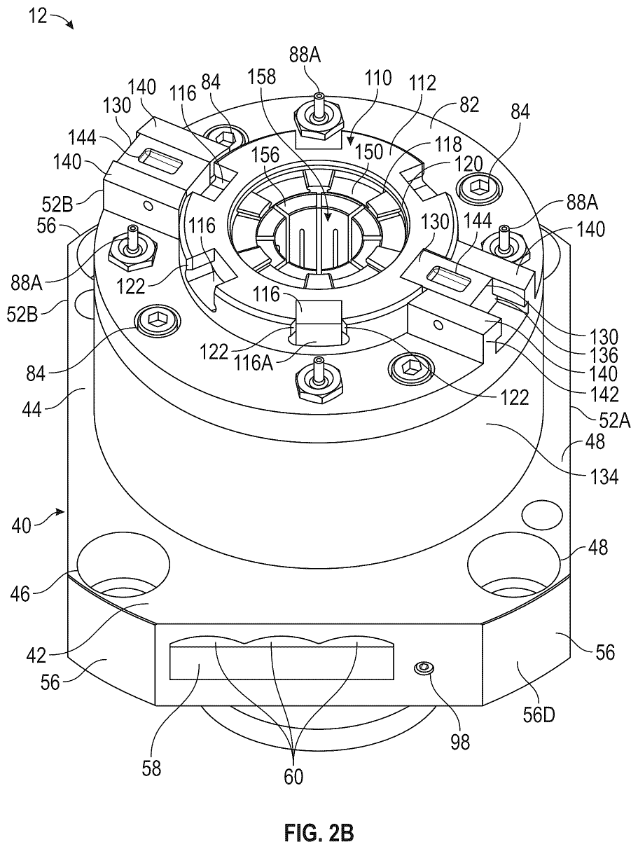

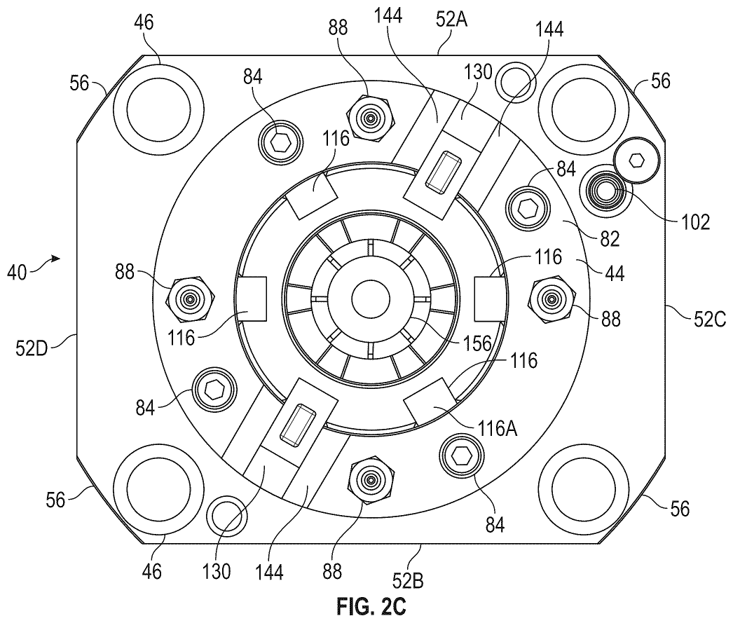

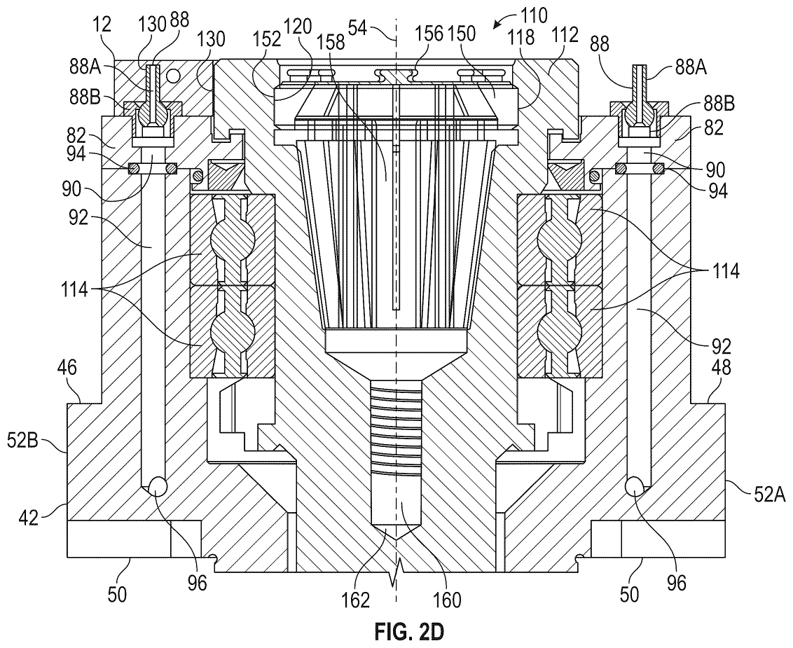

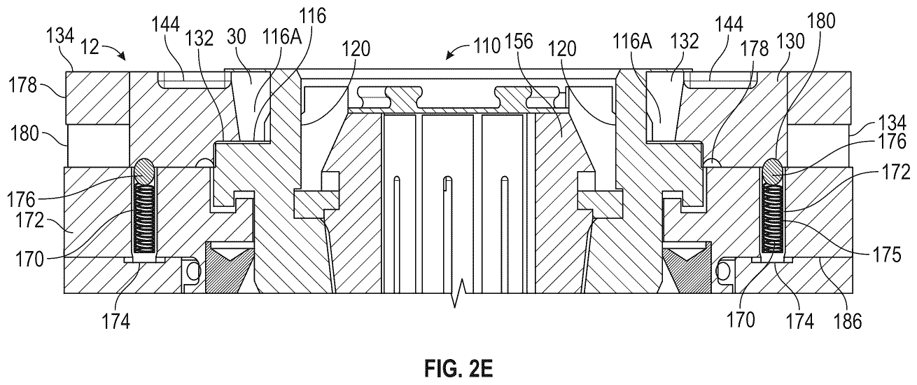

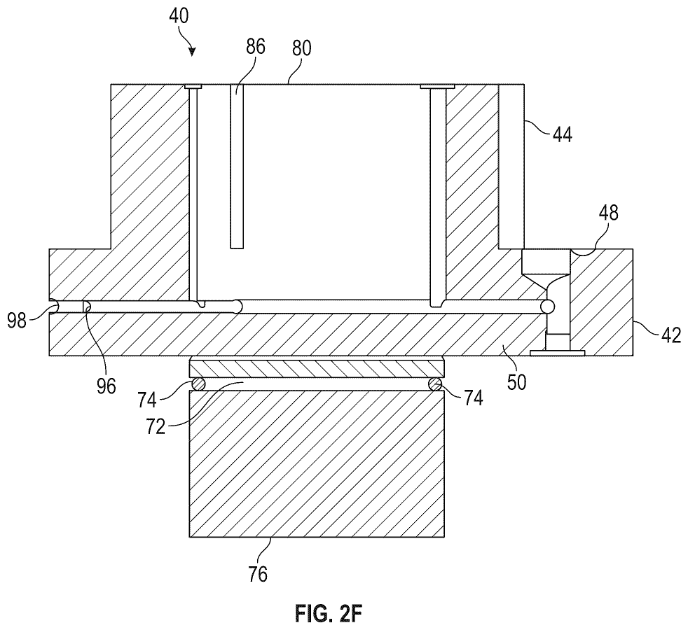

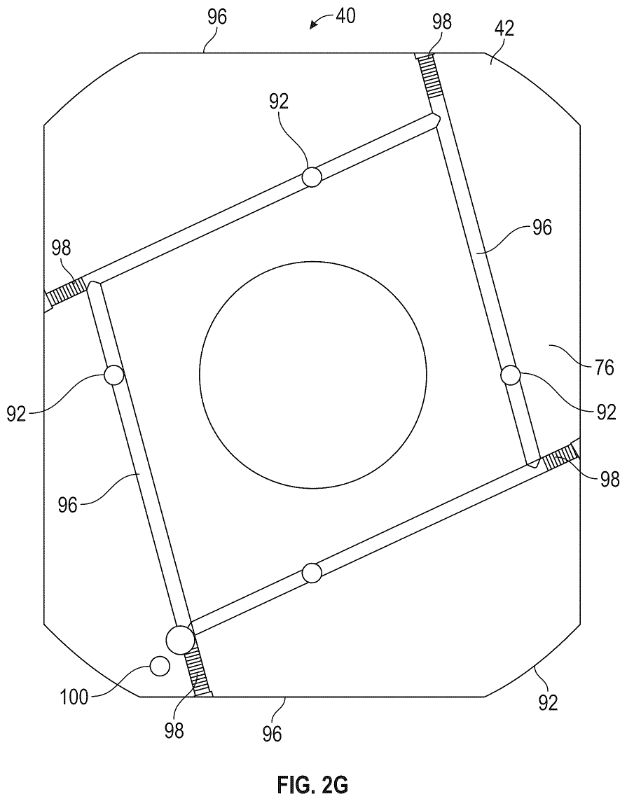

Referring now to FIGS. 2A-2G, tool holder 12 is illustrated in further detail. The tool holder 12 has a body 40. The body 40 includes a base 42 and a spindle housing 44. The base 42 and the spindle housing 44 may be integrally formed. In this example, the base 42 is rectangular in shape. Specifically, the base 42 has bolt holes 46 that extend therethrough for securing the tool holder 12 to the turret 26. The position of the bolt holes 46 depends on the receiving holes within the turret 26. Likewise, the shape of the base 42 may depend upon the position of the corresponding shape of the turret 26. The base 42 has a planar surface 48, a second planar surface 50 and longitudinally extending walls 52 that extend between the surface 48 and the surface 50. The tool holder 12 has a longitudinal axis 54 and therefore the longitudinal extending walls 52 extend widthwise in the longitudinal direction. In this example, four longitudinal extending walls 52A, 52B, 52C and 54D are illustrated. The walls 52A and 52B are opposite each other. Likewise, longitudinally extending walls 52C and 52D are opposite each other. In this example, a chamfered wall 56 extends between the adjacent longitudinally extending walls 52. The chamfered walls 56 are also longitudinally extending. In this example, two opposite extending walls 56C and 56D have recessed grips 58 formed therein. The recessed grips 58 extend radially inward may be elongated in shape and generally rectangular. However, in this example, the recessed grips 58 have finger position 60 in the outermost surface. In this example, three finger positions 60 are provided. However, fewer or greater number of finger positions 60 may be provided within each recessed grip 58. The recessed grips 58 are provided on opposite sides of the base 42 so that sufficient force may be provided to remove the tool holder 12 from the machine tool 10. Alternatively, the recessed grip may be included in the spindle housing 44.

As is best illustrated in FIG. 2F, the body 40 includes a seal channel 72 that may be used to house a seal 74. The seal channel 72 has the seal 74 that extends therein to seal the tool holder 12 to the coolant source (not shown) within the machine tool 10. A receiver 76 is sized to receive a shaft of the machine tool 10 that rotates the spindle of the tool holder 12 relative to the body 40.

The spindle housing 44 has a spindle housing end surface 80 which, in this example, is parallel to and spaced apart from the plane of the base 42. The spindle housing 44 also has a faceplate 82 that is coupled to the spindle housing end surface 80 that has the faceplate 82 coupled thereto. The faceplate 82 is secured to the spindle housing 44 using bolts 84. The bolts 84 may be accommodated in predrill bores 86 within the spindle housing 44. The bolts 84 extend in a longitudinal direction. In the present example, four bolts 84 are used within four bores 86. However, various number of bolts 84 may be used.

The faceplate 82 also has a plurality of movable cooling nozzles 88 disposed therein. The cooling nozzles 88 have an outlet 88A and a base 88B that is affixed to the spindle housing at the faceplate 82. The base plate 88B remains fixed while the outlets 88A are movable and may swivel relative to the base plate 88B to allow coolant traveling therethrough to be directed precisely to the workpiece where desired. By providing multiple movable coolant nozzles 88, the workpiece may be sufficiently cooled.

The coolant nozzles 88 are coupled to coolant passages 90 that extend longitudinally through the faceplate 82. The coolant passages 90 align with coolant passages 92 that extend longitudinally through the spindle housing 44 toward the base 42 of the body 40. The coolant passages 92 and the coolant passages 90 may have a seal 94 disposed therebetween to prevent coolant leakage between the faceplate 82 and the spindle housing 44. The coolant passages 92 may intersect with laterally extending coolant passages 96. The laterally extending coolant passages 96 may be formed through the longitudinal extending walls 52A-52D by boring in a direction normal to the walls 52A-52D. The laterally extending cooling passages 96 may have plugs 98 so that a continuous path for the coolant passages is formed. The laterally extending cooling passages 96 may communicate with a coolant inlet 100. That is, a coolant inlet 100 may receive coolant that is communicated from the coolant inlet 100 to the laterally extending cooling passages 96 and through the vertical coolant passages to the coolant nozzles 88 through the coolant passages 90. By providing the coolant nozzles 88 in a more outboard position, coolant may be more accurately communicated to the workpiece.

In addition, a base coolant nozzle 102, which may also be directional like the coolant nozzles 88, may be positioned on the surface 48 of the base 42. Although a cross-sectional view is not illustrated through the coolant nozzle 102, the cross section may be similar to of the other nozzles 88 illustrated in FIG. 2D.

The spindle housing 44 receives a spindle assembly 110. The spindle assembly 110 includes a spindle 112 that rotates relative to the body 40. The spindle housing 44 may have two sets of bearings 114 that allow the spindle 112 to rotate relative to the spindle housing 44. The spindle 112 rotates under the power of the machine tool 10 illustrated in FIG. 1.

The spindle 112 extends longitudinally outward from the faceplate 82. The spindle 112 has a plurality of receivers 116 that extend radially into the spindle 112 from an outer diameter thereof. The receivers 116 may be but not limited to slots, holes, keyways or grooves. The receivers 116 extend radially toward an inner surface 118 of the spindle 112. The inner surface 118 may be threaded with threads 120.

In this example, the receivers 116 are generally rectangular in shape but have chamfers 122 on the outer surface thereof to allow a movable element 130 to be more easily received therein. In this example, the movable element is a sliding element. In FIG. 2B, two moveable elements 130 are illustrated. One movable element 130 is received within a receiver 116 in an inboard position while the other is shown in an outboard position not engaging a receiver 116. The number of receivers 116 may be greater than the number of moveable elements. The moveable elements 130 are on opposite sides of the spindle 112 in this example.

The movable element 130 is a slidable element that is generally rectangular in shape and has a notch 132 as illustrated in FIG. 2E. The direction of sliding in this example is radial. The notch 132 accommodates the step 134 at the receivers 116. The step 134 is caused from the spindle and the receiver 116 that is disposed away from the surface of the faceplate 82. That is, the laterally extending surface 116A of the receivers 116 are positioned space apart from the surface of the faceplate 82.

The movable elements 130 include flanges 136 that extend angularly from the movable elements 130 adjacent to the faceplate 82. The flanges extend the radial length of the movable elements 130 up to the notch 132.

The movable elements 130 are received between two guide walls 140. The guide walls 140 extend in a direction from the spindle radially outwardly toward the end of the faceplate 82. In this example, the guide walls 140 each have a channel 142. The channels 142 extend in an annular direction into the guide walls 140 so that the flanges 136 are received and are moveable therein.

The movable elements 130 may also have a detent 144 in an outward surface thereof. The detent 144 is recessed to allow the finger of an operator to be positioned therein to assist in the radially movement of the movable elements 130. A tool engaging the detent 144 may also be used to assist in moving the movable element 130. A finger may be positioned therein. However, a tool or other force may be applied to the detent 144 to move the moveable element 130.

The spindle 112, as mentioned above, has threads 120 disposed in the inner surface 118 of the spindle 112 and are used to receive an adapter nut 150. The adapter nut 150 has outer threads 152 that are received by the threads 120 and allow the adapter nut 150 to secure an adapter 156 therein. The use of the adapter nut 150 to secure an adapter 156 is well known in the industry. The adapter nut 150 is tightened to allow the adapter 156 to squeeze and hold the tool that is placed within the opening 158 within the adapter 156. One example of an adapter 156 is a collet and therefore the adapter nut 150 may be a collet nut.

Referring now to FIG. 2E, the movable element 130 may be retained by a movable element retainer 170. The movable element retainer 170 may be located within a channel 172 and may have a screw 174 to fix the movable element retainer 170 therein. The movable element retainer 170 may have a ball 176 that is spring loaded by a spring 175 and is biased outwardly toward an opening 186 that is smaller than the ball 176. Detents 178 and 180 may be used to position or hold the movable element 130 in an inboard position as illustrated in FIG. 2E on the right side of FIG. 2B or an outboard position as illustrated on the left side of FIG. 2B. The first detent 178 is used to hold the movable element 130 in the outboard position when engaging the ball 176. The second detent 180, if used, secures the movable element 130 in the inboard most position so that the movable element 130 is positioned within the receiver 116.

In the present example to remove or insert a tool within the tool holder, the adapter nut 150 is loosened to allow the adapter 156 to expand allowing the tool to be received within the adapter 156. To allow the adapter nut 150 to be removed with a single tool, the movable elements 130 are moved into a radially inward position or inboard position so that the movable element 130 engages the receivers 116 to prevent rotational movement of the spindle assembly 110. Although two movable elements 130 are illustrated in this example, one movable element 130 or more than two movable elements 130 may be used. The chamfers 122 allow the rectangular edges of the movable elements 130 to be easily aligned and received within the receivers 116.

The adapter 156 may be positioned by a tool length positioner 160. The tool length positioner 160 is a bolt or fastener received within a channel 162. The tool length positioner 160 may be a threaded fastener that is positioned selectively by the operator.

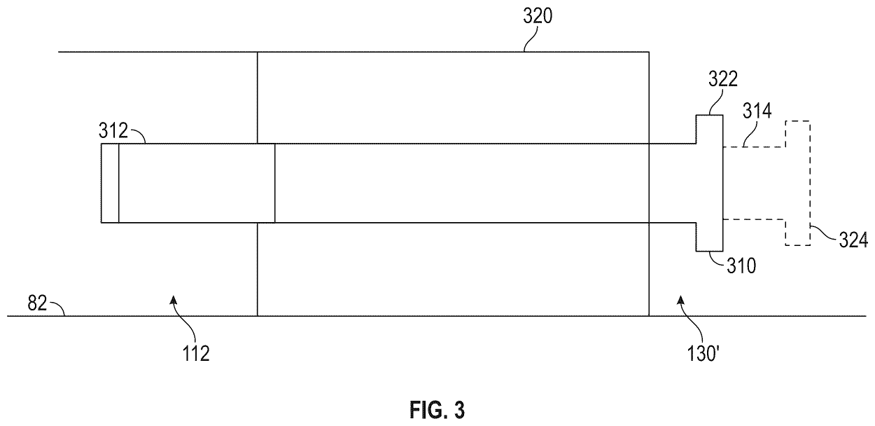

Referring now to FIG. 3, an alternative movable element 130′ is set forth. Instead of a rectangular movable element, a pin 310 may be aligned with and positioned into a hole or opening 312 of the spindle 112. The pin 310 illustrated in FIG. 3 is in the innermost position. The outermost position of the pin 310 is illustrated by the dashed lines 314. The pin 310 may be moved in an inward and outward position and slidably engage a wall 320. The pin 310 may have a head 322 that allows a gripping surface to pull the pin 310 from within the opening 312 within the spindle 112. An outboard position of the pin is illustrated by the dashed lines of 324.

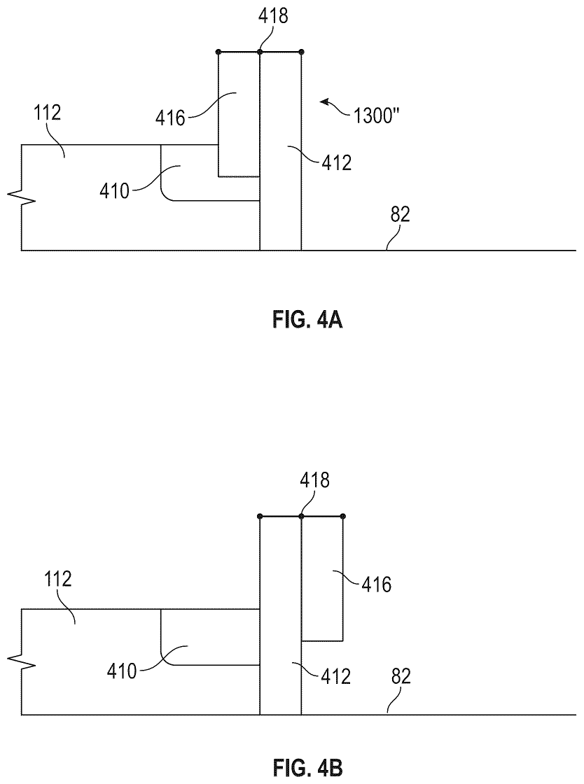

Referring now to FIGS. 4A and 4B, another example of a movable element 130″ is set forth. The spindle 112 is illustrated having a notch 410 extending therein. The notch 410 may generally correspond to the receiver above and may also be referred to as a receiver. In this example, the movable element 130″ is a rotatable element that has a longitudinally extending wall 412 that extends laterally from the faceplate 82. A rotating wall 416 may be rotated from a locked position illustrated in FIG. 4A to an unlocked position in FIG. 4B. A hinge 418 may allow the movement of the rotating wall 416 from an unlocked to a locked position.

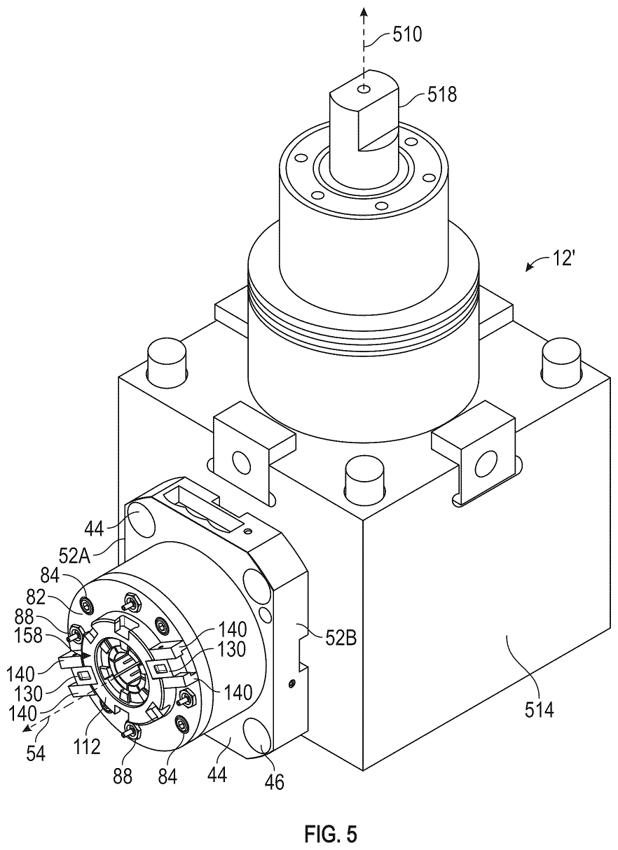

Referring now to FIG. 5, another configuration of a tool holder 12′ is illustrated. The first surface of the tool holder 12′ is configured in the same way or similar way as that set forth in FIG. 2B. However, the tool holder 12 of FIGS. 2A-2G are referred to as a radial tool holder meaning that the spindle 112 extends in a longitudinal direction into the turret 26. However, the teachings of the present disclosure may also be applied to an axial drive for the tool holder 12. FIG. 5 illustrates a drive axis 510 that is different from a longitudinal axis 512 of the spindle 112. A housing 514 thus has gears (not shown) therein to allow the spindle axis 512 and the axis 510 of the drive 518 to be perpendicular to each other.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A tool holder comprising:
a body comprising a base and a spindle housing;
a spindle assembly rotatably coupled to the base, said spindle assembly comprising an adapter and a spindle;
an adapter nut coupling the adapter to the spindle; and
a first movable element coupled to the spindle housing selectively engaging the spindle, the first movable element comprising a locked and an unlocked position.

2. The tool holder of claim 1 wherein the spindle comprises an inner surface receiving the adapter nut.

3. The tool holder of claim 1 wherein the spindle comprises a first end extending from the spindle housing, said spindle comprising a first receiver sized to receive the first movable element.

4. The tool holder of claim 3 wherein the first movable element comprising a first sliding element.

5. The tool holder of claim 4 wherein the first sliding element is disposed between a first wall coupled to the spindle housing and a second wall coupled to the spindle housing.

6. The tool holder of claim 5 wherein the first wall and the second wall are radially extending.

7. The tool holder of claim 6 wherein the first wall comprises a first channel and the second wall comprises a second channel, and wherein the first wall comprises a first flange slidably engaging the first channel and a second wall slidably engaging the second channel.

8. The tool holder of claim 7 wherein the first channel and the second channel are defined by a faceplate of the spindle housing.

9. The tool holder of claim 5 wherein the first end comprises a movable element retainer retaining the movable element in an outboard position.

10. The tool holder of claim 9 wherein the movable element retainer is disposed between the first wall and the second wall, the movable element retainer comprises a channel disposed in the end of the spindle housing, a ball disposed in the channel, the channel comprising an opening smaller than the ball and a spring biasing the ball toward the opening.

11. The tool holder of claim 10 wherein the first sliding element comprises a first detent engaging the ball.

12. The tool holder of claim 11 wherein first movable element comprises a second detent, said first detent positioning the movable element in an outboard position and the second detent positioning the movable element in an inboard position.

13. The tool holder of claim 1 further comprising a second movable element coupled to the spindle housing selectively engaging an opposite side of the spindle from the first movable element.

14. The tool holder of claim 1 wherein an end of the spindle housing is spaced apart from the base and comprises a coolant nozzle.

15. The tool holder of claim 1 wherein an end of the spindle housing is spaced apart from the base and comprises a plurality of coolant nozzles disposed around the spindle.

16. The tool holder of claim 15 wherein the plurality of coolant nozzles are movable nozzles.

17. The tool holder of claim 16 further comprising a base coolant nozzle disposed on the base adjacent to the spindle housing.

18. The tool holder of claim 17 wherein the plurality of coolant nozzles is coupled to longitudinally extending channels disposed within the spindle housing.

19. The tool holder of claim 1 wherein the base comprises longitudinally extending walls disposed around a longitudinal axis, wherein a first wall of the longitudinally extending walls comprises a first recessed grip and a second wall of the of the longitudinally extending walls comprises a second recessed grip.

20. The tool holder of claim 19 wherein the first recessed grip comprises finger positions.

21. A tool holder comprising:
a body comprising a base and a spindle housing;
a spindle assembly rotatably coupled to the base, said spindle assembly comprising an adapter and a spindle extending from the spindle housing;
an adapter nut coupling the adapter to a spindle; and
a first sliding element slidably disposed between a first wall and a second wall extending from the spindle housing and a second sliding element disposed between a third wall and a fourth wall extending from the spindle housing, the second sliding element, the third wall and the fourth wall coupled to an opposite sides of the spindle housing from the first sliding element, the first wall and the second wall, said first sliding element selectively engaging the spindle at a first receiver at a first locked position, the second sliding element selectively engaging the spindle at a second receiver at a second locked position.

22. The tool holder of claim 21 wherein an end of the spindle housing is spaced apart from the base and comprises a plurality of coolant nozzles disposed around the spindle.

23. The tool holder of claim 21 wherein the base comprises longitudinally extending walls disposed around a longitudinal axis of the body, wherein a first wall of the longitudinally extending walls comprises a first recessed grip and a second wall of the of the longitudinally extending walls comprises a second recessed grip.
